(19) United States
(12) Patent Application Publication
(10) Pub. No.: US 2016/0372986 A1
(43) Pub. Date: Dec. 22, 2016

(54) ELECTRIC MACHINE

(71) Applicant: AUDI AG, Ingolstadt (DE)

(72) Inventors: Kai Brune, Hepberg (DE); Vladimir Chernogorski, Ingolstadt (DE); Peter Juris, Hannover (DE); Andre Brune, Hannover (DE)

(73) Assignee: AUDI AG, Ingolstadt (DE)

(21) Appl. No.: 15/183,326

(22) Filed: Jun. 15, 2016

(30) Foreign Application Priority Data
Jun. 16, 2015 (DE) 10 2015 007 588.8

(51) Int. Cl. H02K 5/124; H02K 9/00

(52) U.S. Cl. CPC H02K 5/124; H02K 9/00

(57) ABSTRACT

An electric machine, includes a housing; a rotor supported for rotation relative to the housing about a rotation axis, wherein the rotor has at least one rotor projection which extends axially toward the housing, wherein the housing has at least one housing projection which extends axially toward the rotor, wherein the rotor projection and the housing projection overlap each other in a direction along the rotation axis; and at least one gasket received between the rotor projection and the housing projection for sealing a fluid space formed between the rotor and the housing

### CROSS-REFERENCES TO RELATED APPLICATIONS

This application claims the priority of German Patent Application, Serial No. 10 2015 007 588.8, filed Jun. 16, 2015, pursuant to 35 U.S.C. 119(a)-(d), the content of which is incorporated herein by reference in its entirety as if fully set forth herein.

### BACKGROUND OF THE INVENTION

The present invention relates to an electric machine with a housing and a rotor which is supported for rotation relative to the housing about a rotation axis.

During operation of an electric machine heat is produced which has to be dissipated for example in the direction of an external environment of the electric machine.

It would be desirable and advantageous to provide an improved electric machine that has advantages compared to known electric machines, in particular an efficient cooling and a long service life.

### SUMMARY OF THE INVENTION

According to one aspect of the present invention an electric machine, includes a housing; a rotor supported for rotation relative to the housing about a rotation axis, wherein the rotor has at least one rotor projection which extends axially toward the housing, wherein the housing has at least one housing projection which extends axially toward the rotor, wherein the rotor projection and the housing projection overlap each other in a direction along the rotation axis; and at least one gasket received between the rotor projection and the housing projection for sealing a fluid space formed between the rotor and the housing.

The electric machine has a fluid space, which is present between the rotor and the housing. In the fluid space preferably a heat transfer fluid is present, particularly preferably the fluid transfer fluid completely fills the fluid space. The fluid space is arranged directly between the rotor and the housing. This means that at least regions of the fluid space are delimited by the rotor and by the housing. The heat transfer fluid provided in the fluid space thus ensures an efficient cooling also of the rotor. The heat generated or present at the rotor is transferred via the heat transfer fluid to the housing and is dissipated by the housing. Such a configuration of the electric machine enables reducing the temperature difference between the rotor and the housing or the temperature gradient between the rotor and the housing. This decrease ensures a longer service life, in particular of the bearing used to support the rotor.

For sealing the fluid space against other regions of the electric machine the at least one gasket is provided. The gasket is present between the rotor projection and the housing projection. This means that on one hand the gasket contacts or is fastened on the rotor projection and on the other hand the gasket contacts or is fastened on the housing projection. The gasket is for example formed by a fastening ring and a flexible sealing lip extending from the fastening ring. The fastening ring can for example be fastened on the rotor projection, while the flexible sealing lip sealingly rests against the housing projection. Vice versa the fastening ring can of course also be fastened on the housing projection, while the flexible sealing lip sealingly rests against the rotor projection. The sealing lip is preferably configured integrally with and/or made of the same material as the fastening ring.

The described configuration of the electric machine realizes a particularly space-saving arrangement of the gasket, while at the same time ensuring an excellent sealing effect and a long service life. The rotor projection is assigned to the rotor and extends in axial direction toward the housing. Vice versa the housing projection is provided on the housing and extends in axial direction toward the rotor. This means that the rotor projection and/or the housing projection when viewed in longitudinal section have a main direction of extent, which has an axial component which is greater than a radial component. Particularly preferably the main direction of extent of the rotor projection and/or the housing projection extends exactly in axial direction, i.e., it is oriented parallel to the rotation axis. The rotor projection and the housing projection are arranged spaced apart from each other in radial direction and when viewed in longitudinal section overlap with each other along the rotation axis. This overlap ensures the sealing of the fluid space.

According to another advantageous feature of the invention, the rotor projection can be formed on a heat transfer element, which is fastened thermally conductively on a squirrel cage rotor of the rotor. Generally the electric machine can be configured in any desired manner, i.e., it can have any desired design. Particularly preferably however the electric machine is constructed as induction machine or as asynchronous machine. Correspondingly the rotor has the squirrel cage rotor or is configured as squirrel cage rotor, the heat transfer element is thermally conductively connected with the squirrel cage rotor, preferably the squirrel cage rotor rests flat against the heat transfer element and is fastened thereon. Particularly preferably the heat transfer element has an extent in radial direction, which is dimensioned so that the squirrel cage rotor when viewed in longitudinal section is completely covered or overlapped.

For example the heat transfer element is formed by a centrifugal force securing element, in particular the squirrel cage rotor. The centrifugal force securing element is thus assigned to the rotor. The centrifugal force securing element is configured so that at least regions of the rotor can be supported outwardly on the centrifugal force securing element. This is in particular important in the case of high centrifugal forces of the electric machine at which otherwise a widening of the rotor or the squirrel cage rotor may occur due to centrifugal forces. The centrifugal force securing element allows preventing such a widening. For this purpose the centrifugal force securing element is preferably configured rigid and/or solid. The heat transfer element forms a component of the centrifugal force securing element or is formed by the centrifugal force securing element. This means that the at least one rotor projection extends from the centrifugal force securing element, and is in particular formed from the same material and/or integrally one-piece with the centrifugal force securing element.

According to another advantageous feature of the invention, a wall of the rotor and/or the housing, which delimits the fluid space, can have a surface-enlarging structure. By means of the surface-enlarging structure the surface of the wall of the rotor or the housing that is wetted by the heat transfer fluid is enlarged compared to a smooth wall. Correspondingly the amount of heat that can be transferred from the respective wall to the heat transfer fluid or vice versa is increased. The surface-enlarging structure has for example at least one rib, particularly preferably a plurality of ribs. For example the ribs are arranged concentrically, in particular toward the rotation axis. Due to the concentric arrangement of the ribs the friction loss resulting from the heat transfer fluid and the surface-enlarging structure is decreased and at the same time the surface available for heat transfer is increased.

According to another advantageous feature of the invention, the housing can have at least one coolant channel of a coolant circuit. As described above, the electric machine is preferably cooled actively. For this purpose the coolant circuit is provided via which coolant can be supplied to the electric machine. In the housing the at least one coolant channel is formed through which preferably coolant flows during operation of the electric machine.

According to another advantageous feature of the invention, a sealing can be arranged between the rotor and the housing, wherein the sealing of the fluid space is accomplished on one hand by means of the gasket and on the other hand by means of the sealing. In addition to the gasket mentioned above the sealing is arranged between the rotor and the housing. Like the gasket the sealing serves for sealing the fluid space. The gasket and the sealing are preferably arranged spaced apart form each other, in particular in axial and/or radial direction. The fluid space is correspondingly sealed on one hand by the gasket and on the other hand by the sealing. The sealing also rests against the rotor as well as against the housing. In this way the sealing can seal the fluid space against adjacent regions of the electric machine.

According to another advantageous feature of the invention, the sealing can be constructed as a further gasket or as a bearing, in particular as a rotary bearing for supporting the rotor relative to the housing. On one hand the sealing can be configured as gasket and thus be formed in analogy to the description above regarding the gasket from a fastening ring and a sealing lip extending from the fastening ring. For example the further gasket differs from the gasket regarding its diameter. In such a configuration the gaskets can be arranged spaced apart from each other in radial direction but may overlap each other in axial direction. As an alternative the sealing can also be constructed as a bearing. The bearing can for example be configured as a sliding bearing or a rolling bearing. Particularly preferably the bearing serves for supporting the rotor relative to the housing and can thus be referred to as rotor bearing. For example a shaft of the rotor is supported for rotation relative to the housing. The bearing is hereby configured fluid tight or substantially fluid tight, so that the heat transfer fluid cannot leak from the bearing but is held in the fluid space.

According to another advantageous feature of the invention, the gasket and the further gasket are arranged so as to overlap in axial direction. Such a configuration was mentioned above. In such a configuration the gaskets usually have different diameters so that they are arranged offset to each other in radial direction but overlap in axial direction and/or are provided at the same axial position.

According to another advantageous feature of the invention, the further gasket is assigned to a further housing projection and/or to a further rotor projection. The further gasket thus sealingly rests against the further housing projection and/or the further rotor projection. The further gasket is for example arranged between the further housing projection and the further rotor projection. The further housing projection is assigned to the housing and extends toward the rotor in axial direction. Analogously the further rotor projection is assigned to the rotor or forms a part of the rotor and extends toward the housing in axial direction. Particularly preferably the further housing projection is arranged parallel to the housing projection and/or the further rotor projection is arranged parallel to the rotor projection. In particular the further housing projection, when viewed in cross section, is arranged so as to overlap with the housing projection and the further rotor projection when viewed in longitudinal section is arranged so as to overlap with the rotor projection.

According to another advantageous feature of the invention, when viewed in longitudinal section of the electric machine, the housing projection is received between the rotor projection and the further rotor projection. The rotor has thus the rotor projection and the further rotor projection, which extend in the direction of the housing and are arranged parallel to each other. In particular the rotor projection and the further rotor projection are situated at the same axial position and have the same extent in axial direction. Between the rotor projection and the further rotor projection a hollow space is formed into which the housing projection protrudes. The fluid space is thus delimited by the housing projection, the rotor projection and the further rotor projection. For example the gasket is present between the housing projection and the rotor projection and the further gasket is present between the housing projection and the further rotor projection, so that the housing projection is sealingly embraced from both sides.

According to another advantageous feature of the invention, the fluid space can also be delimited by a shaft of the rotor. In such an embodiment the shaft is at least temporarily in contact with the heat transfer fluid present in the fluid space. Correspondingly heat can be dissipated directly from the shaft. This further improves cooling of the rotor.

For example in a preferred embodiment of the invention the further gasket is arranged between the housing and the shaft. This means that the further gasket sealingly rests against the housing as well as the shaft. This effectively prevents leakage of the heat transfer fluid out of the electric machine.

According to another advantageous feature of the invention, the fluid space can be fluid tight and contains a heat transfer fluid. The fluid space is thus preferably filled with the heat transfer fluid only once and is subsequently operated without exchanging the heat transfer fluid. For example in the fluid space an amount of the heat transfer fluid is arranged which is sufficient over the entire service life of the electric machine. Thus an effective cooling can be ensured over the entire service life of the electric machine even without the requirement of exchanging and/or refilling the heat transfer fluid. The heat transfer fluid is preferably an oil in particular a thermal oil. The oil can for example be a mineral oil, a synthetic oil or the like. For example a silicone oil is used.

According to another advantageous feature of the invention, the fluid space can be connected to a coolant circuit. As mentioned above the electric machine can be connected to the coolant circuit. In particular it is hereby provided to cool the housing by means of the coolant circuit or the coolant circulating in the coolant circuit. In addition the coolant is also supplied to the fluid space and serves as heat transfer fluid in the fluid space. In this embodiment of the electric machine the heat transfer fluid is thus present in the form of the coolant. For example, viewed in longitudinal section, the coolant is supplied on one side of the longitudinal center axis and removed again on the other side of the longitudinal center axis. Correspondingly the coolant or heat transfer fluid flows around the shaft in the fluid space so that a uniform cooling over the entire cross section of the electric machine is ensured.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 shows a sectional view through a first embodiment of an electric machine, wherein a fluid space is provided between a rotor and a housing of the electric machine;

FIG. 2 shows a sectional view through a second embodiment of the electric machine;

FIG. 3 shows a longitudinal sectional view through a region of he electric machine in a third embodiment; and

FIG. 4 shows a longitudinal section view though a fourth embodiment of the electric machine.

### DETAILED DESCRIPTION OF PREFERRED EMBODIMENTS

Throughout all the Figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

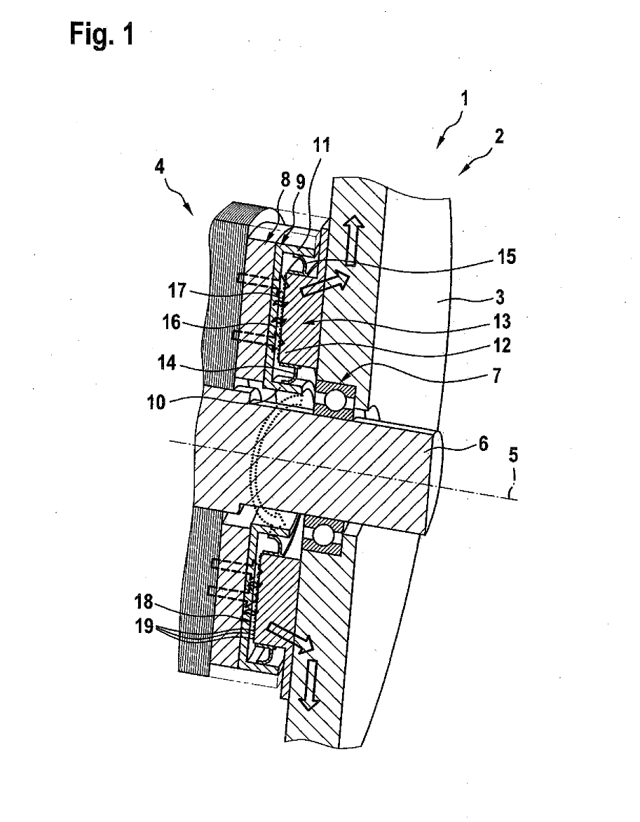

FIG. 1 shows a sectional view through a region of an electric machine 1, wherein a region of the housing 2, in particular a bearing plate 3 of the housing 2 can be recognized. The electric machine 1 also has a rotor 4, which is supported for rotation relative to the housing 2 about a rotation axis 5. For this purpose the rotor 4 has a shaft 6 which is supported by a bearing 7, for example a rolling bearing, on the housing in particular on the bearing plate 3. The bearing 7 is hereby preferably completely received in the bearing plate 3 viewed in axial direction relative to the rotation axis 5. The rotor 4 also has a squirrel cage rotor 8, which in the here shown exemplary embodiment engages completely around the shaft in circumferential direction and is correspondingly configured circular.

Directly adjacent to the squirrel cage rotor 8 in axial direction a heat transfer element 9 is provided which preferably rests flat against the squirrel cage rotor 8 and is fastened on the same. The rotor 4 or the heat transfer element 9 has a rotor projection 10 and a further rotor projection 11. The rotor projection 10 and the further rotor projection 11 extend in axial direction and hereby extend in opposition to the housing 2 in particular the bearing plate 3. When viewed in longitudinal section the rotor projection 10 and the further rotor projection 11 preferably extend exclusively in axial direction, i.e., they are oriented parallel to each other and parallel to the rotation axis 5.

The housing 2 has a housing projection 12, which when viewed in longitudinal section, engages between the rotor projection 10 and the further rotor projection 11. When viewed in longitudinal section the housing projection 12 is thus received between the rotor projection 10 and the further rotor projection 11. The housing projection 12 is for example a part of the bearing plate 3 and is thus formed integrally in one piece with and/or from the same material as the bearing plate. As an alternative however the housing projection 12 can also be present at a separate coolant element 13, which rests flat against the housing 2, in particular the bearing plate 3 and is fastened thereon.

A gasket 14 is assigned to the rotor projection 10 and a sealing 15 to the further rotor projection 11, wherein in the here shown exemplary embodiment the sealing 15 is constructed as a further gasket. The gasket 14 sealingly rests against the housing projection 12 and the rotor projection 10. The further gasket 15 on the other hand sealingly rests against the housing projection 12 as well as the further rotor projection 11. Insofar the gasket 14 is received between the rotor projection and the housing projection 12 and the further gasket 15 is received between the further rotor projection 11 and the housing projection 12. Hereby a fluid space 16 present between the rotor 4 and the housing 2 is sealed. In the fluid space 16 preferably a heat transfer element is arranged. In particular the fluid space 16 is completely filled with the heat transfer fluid. The heat transfer fluid can be for example an oil, in particular a thermal oil or the like.

In the here shown embodiment the fluid space is fluid tight and is delimited by the housing 2 in the form of the coolant element 13, the rotor 4 in the form of the heat transfer element 9 and the gaskets 14 and 15. Hereby a wall 17 of the housing projection 12, which delimits the fluid space 16, can have a surface-enlarging structure 18. The surface-enlarging structure for example has a plurality of ribs 19 of which in the instant case only several are schematically indicated. The ribs 19 are preferably arranged concentrically relative to the rotation axis 5. Such a configuration of the electric machine 1 enables realizing a particularly efficient cooling of the rotor 4 in particular the squirrel cage rotor 8.

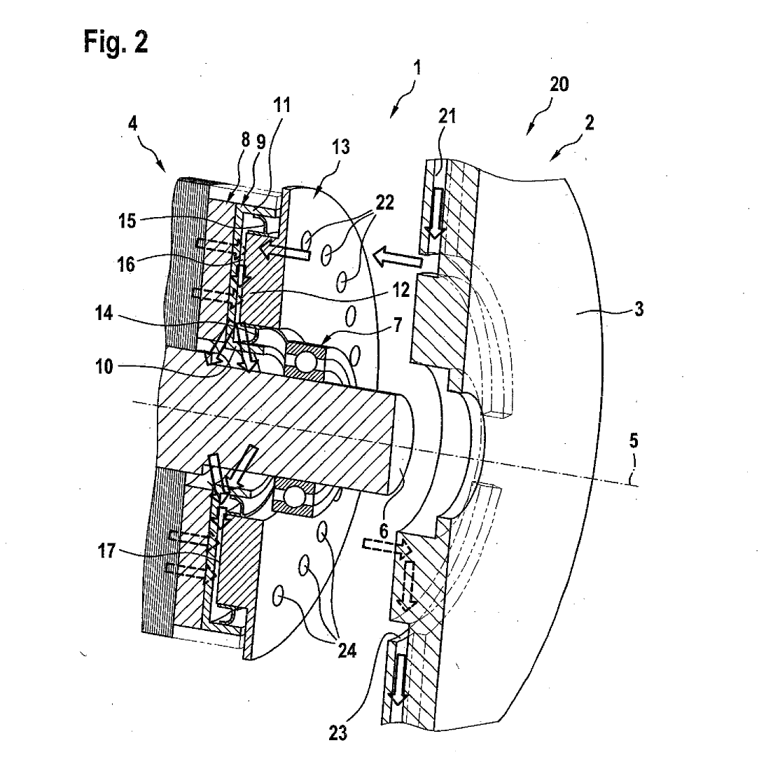

FIG. 2 shows a view of a section through a second embodiment of the electric machine 1. Reference is made to the description above, wherein in the following the differences are discussed. In the present illustration the bearing plate 3 is shown offset relative to the coolant element 1. The difference to the first embodiment is that the fluid space 16 is fluidly connected to a coolant circuit 20. The coolant circuit 20 has at least one coolant channel 21, which in the here shown exemplary embodiment extends through the bearing plate 3. The coolant channel 21 is fluidly connected with the fluid space 16 via a through passage 22 which is formed in the coolant element 13.

A further coolant channel 23, which is also formed in the housing 2 or the bearing plate 3, is in fluid communication with the fluid space 16 via the through passage 24. Via the coolant channel 21 and the through passage 22, coolant which is present or circulates in the coolant circuit can be supplied to the fluid space 16. Through the through passage 24 and the coolant channel 23 the coolant can subsequently be removed again from the fluid space 16. Correspondingly is need a constant circulation of the coolant in the fluid space 16 can be effected. In such an embodiment the heat transfer fluid is present in the form of a coolant.

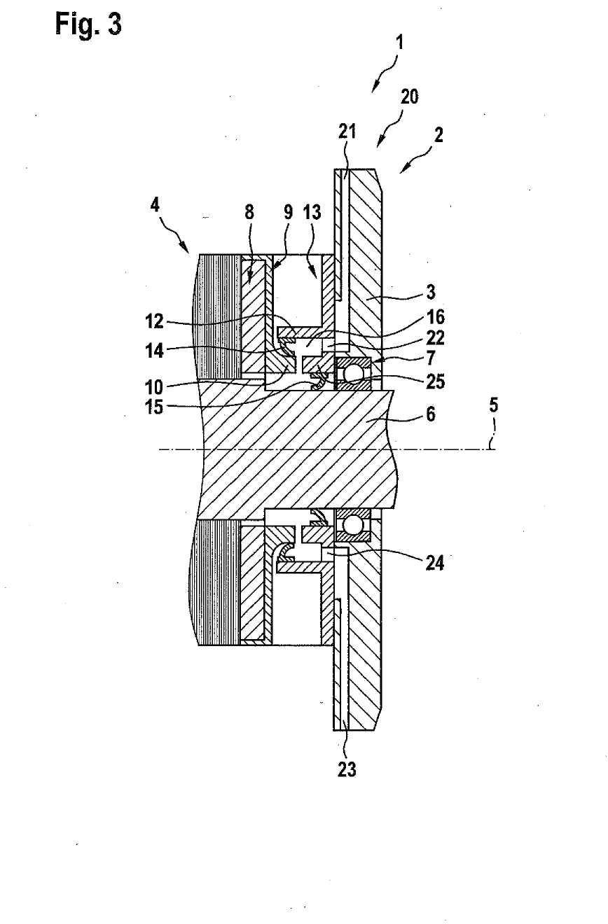

FIG. 3 shows a third embodiment of the electric machine in longitudinal section. In this case the heat transfer element 9 is configured as a centrifugal force securing element for the squirrel cage rotor 8. Such a configuration can of course also be provided in the further embodiments in particular in the first embodiment and the second embodiment. In the following the differences of the embodiment shown in FIG. 3 and the other embodiments described above are discussed. The gasket 14 is also sealingly present between the housing projection 12 and the rotor projection 10. The sealing 15 or the gasket 15 is however arranged between the housing 2 and the shaft 6. This means that the further gasket 15 sealingly rests against the housing, in particular the bearing plate 3 or the coolant element 13, as well as against the shaft 6. Insofar at least regions of the fluid space 16 are delimited by the shaft 6.

Shown here is an embodiment with trough passages 22 and 24. Of course these are purely optional so that also an embodiment without these through passages 22 and 24 van be realized. In this case the fluid space 16 is not fluidly connected with the coolant channels 21 and 23 but is rather fluid tight. The coolant channels 21 and 23 can nevertheless be present in order to realize a cooling of the housing 2. Also n this case however an embodiment without the coolant channels 21 and 23 is possible. The further gasket 15 hereby sealing rests against a further housing projection 25, which is preferably also assigned to the coolant element 13. The further housing projection 25 extends in axial direction toward the rotor 4. For example the housing projection 25 is arranged in abutment with the rotor projection 10.

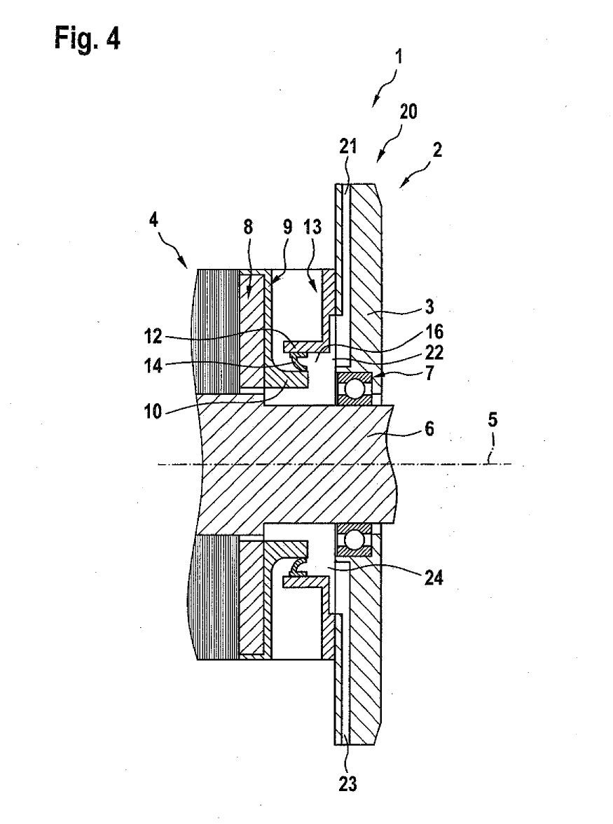

FIG. 4 shows a fourth embodiment of the electric machine 1. This embodiment is similar to the third embodiment so that reference is made to the description above. The difference to the third embodiment is that the further gasket 15 is not required. Correspondingly also the further housing projection 25 is not required. This is realized by using a fluid tight bearing 7. At least regions of the fluid space 16 re insofar delimited by the bearing 7. Also in this case of course an embodiment without the through passages 22 and 24 can be realized.

The electric machine 1 described above is characterized by an excellent coolability of the rotor 4, in particular the squirrel cage rotor 8. The heat accruing at the rotor 4 is conducted by the heat transfer fluid in the direction of the housing 2, preferably in the direction of the bearing plate 3. From the housing 2 or the bearing plate 3 the heat can then be dissipated to an external environment of the electric machine 1.

What is claimed as new and desired to be protected by Letters Patent is set forth in the appended claims and includes equivalents of the elements recited therein:

What is claimed is:

1. An electric machine, comprising:
a housing;
a rotor supported for rotation relative to the housing about a rotation axis, said rotor having at least one rotor projection which extends axially toward the housing, said housing having at least one housing projection which extends axially toward the rotor, said rotor projection and said housing projection overlapping each other in a direction along the rotation axis; and
at least one gasket received between the rotor projection and the housing projection for sealing a fluid space formed between the rotor and the housing.

2. The electric machine of claim 1, further comprising a sealing arranged between the rotor and the housing, said fluid space being sealed on one side by the gasket and on another side by the sealing.

3. The electric machine of claim 2, wherein the sealing is constructed as a further gasket.

4. The electric machine of claim 2, wherein the sealing is constructed as a bearing.

5. The electric machine of claim 4, wherein the sealing is constructed as a rotor bearing for supporting the rotor relative to the housing.

6. The electric machine of claim 3, wherein the gasket and the further gasket are arranged so as to overlap with each other in axial direction.

7. The electric machine of claim 3, wherein the housing has a further housing projection and/or the rotor has a further rotor projection, said further gasket being assigned to the further housing projection and/or the further rotor projection.

8. The electric machine of claim 7, wherein when viewed in longitudinal section, the housing projection is received between the rotor projection and the further rotor projection.

9. The electric machine of claim 1, wherein at least regions of the fluid space are delimited by a shaft of the rotor.

10. The electric machine of claim 9, characterized in that the further gasket is arranged between the housing and the shaft of the rotor.

11. The electric machine of claim 1, wherein the fluid space is fluid tight and contains a heat transfer fluid.

12. The electric machine of claim 1, further comprising a coolant circuit, said fluid space being fluidly connected to the coolant circuit.
